(19) United States
(12) Patent Application Publication
(10) Pub. No.: US 2011/0113666 A1
(43) Pub. Date: May 19, 2011

(54) SHOCK ABSORBING PAD FOR RIFLE OR THE LIKE

(76) Inventor: Willard M. Latimer, Chehalis, WA (US)

(21) Appl. No.: 12/622,154

(22) Filed: Nov. 19, 2009

(51) Int. Cl. F41C 23/08; B23P 11/00

(52) U.S. Cl. 42/74; 29/530

(57) ABSTRACT

An improved recoil pad for use with a rifle or the like uses an outer shell of relatively durable material and an inner region filled with cushioning material such as Sorbothane® to provide recoil cushioning and protection against wear and tear.

### BACKGROUND OF THE INVENTION

1. Field of the Invention

The present invention relates to an improved pad for absorbing recoil from a rifle or the like.

2. Description of the Related Art

There are a variety of commercially available pads designed to mount on the end of a rifle or other shoulder-fired gun and absorb the recoil shock when the gun is fired. One such example is KICK EEZ pads sold by I.N.C. of Carl Junction, Mo. These pads extend rearwardly from the rear of a rifle stock and are formed of Sorbothane®, a visco elastic polymer that provides a cushioning to absorb recoil shock when the gun is fired. Another example is shown in Published Application No. US2002/0088161 to Sims for “Recoil Reducing Accessories for Firearms.”

### BRIEF SUMMARY OF THE INVENTION

The present invention involves using, in the embodiments disclosed herein, a recoil pad comprising an outer shell of rubber material or the like and an inner cavity of Sorbothane or similar material. This design allows the outer shell to protect the pad from wear and tear while the interior cavity of more recoil absorbent material provides the desired cushioning.

In embodiments, a recoil pad is provided that comprises a backing plate configured to be affixed to a rear handle or support of a gun, such as a stock of a rifle or shotgun. Attached to the backing plate is a shell, with the shell and backing plate combination defining an interior region that is filled with Sorbothane. A durable material such as rubber may be used for the shell. A method of manufacturing a recoil pad is also provided. In embodiments of the method, a backing plate is provided, with the backing plate configured to be attached to the rear of a gun, such as on a stock of a rifle or shotgun stock, to absorb recoil shock. A rubber shell is attached to the backing plate, with the rubber shell and backing plate defining an interior region. Other durable materials may be used for the shell. Sorbothane is then heated until it enters a liquid-type state, after which it is poured or otherwise placed into the interior region defined by the rubber shell and backing plate combination. The Sorbothane is then allowed to cool until it hardens. After the Sorbothane cools and hardens, the recoil pad may be attached to the rear of the gun.

### BRIEF DESCRIPTION OF THE SEVERAL VIEWS OF THE DRAWINGS

FIG. 1 is a prospective view of an embodiment of the invention mounted to a rifle stock.

FIG. 2 is a bottom elevation view of the embodiment of FIG. 1.

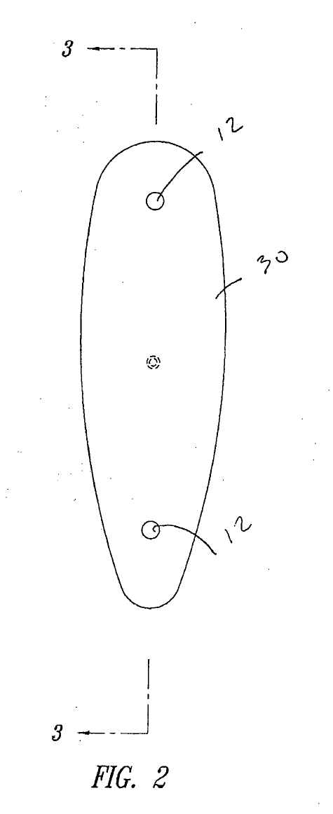

FIG. 3 is a cross-sectional view taken through line 33 of FIG. 2 showing the interior structure of the illustrated embodiment.

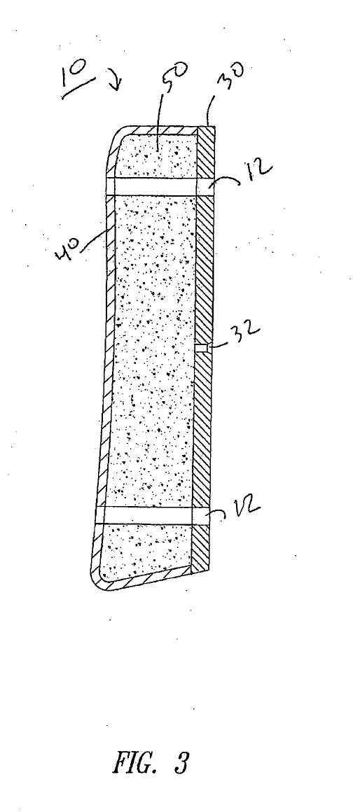

### DETAILED DESCRIPTION OF THE INVENTION

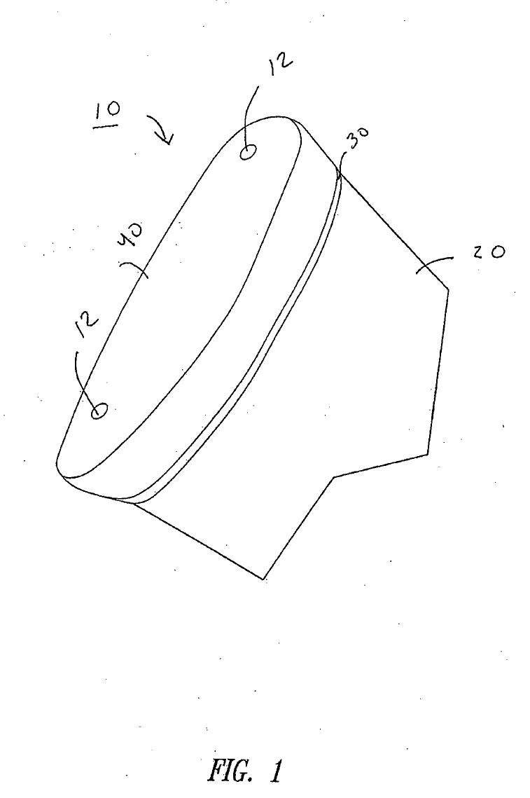

The present invention employs a novel configuration to provide improved performance and resistance to wear and tear in a recoil pad for use with rifles, other shoulder fired guns such as a shotgun, or the like. In the embodiment illustrated in FIG. 1, a recoil pad 10 is mounted to the stock of a rifle 20. The recoil pad mimics the shape of the gun stock, as shown in FIG. 1. In other embodiments, the recoil pad 10 may be larger or smaller than the stock of the rifle 20. In an embodiment, the recoil pad 10 includes two apertures 12 extending through the pad to allow the pad to be secured to the gun stock using screws or the like. In other embodiments, the recoil pad 10 may be coupled or attached to the gun stock using an adhesive or glue. In embodiments, the backing plate 30 of the pad is formed of hardened plastic, metal, wood or other a relatively rigid material(s).

The recoil pad is comprised of the backing plate and outer shell 40 formed of a durable material or combination or materials, such as rubber, which extends substantially around the periphery of the pad. The shell and backing plate combine to form an interior region 50 that is filled with Sorbothane. Sorbothane is a proprietary, thermoset, polyether-based, polyurethane material that is visco-elastic such that it exhibits properties of both liquids (viscous solutions) and solids (elastic materials). Sorbothane is available from Sorbothane, Inc. of Kent, Ohio (www.sorbothane.com). The inventive recoil pad having a rubber shell with a Sorbothane filling has been tested and has provided surprising and superior results in comparison to other materials, such as gels, rubbers, neoprene, silicone, or other shock absorbing materials.

The outer shell 40 of the recoil pad 10 is provided for several reasons and helps provide the surprising and superior results of the inventive recoil pad with an interior having Sorbothane. For example, the outer shell 40 and backing plate 30 combination provides a desirable interior form for the Sorbothane to be poured or injected into where the Sorbothane can harden. The outer shell 40 also provides a protective barrier for the Sorbothane, thereby increasing the life, effectiveness and durability of the recoil pad 10. Significantly, in tests with the outer shell 40 being made of rubber and the interior region of the recoil pad 10 filled with Sorbothane, the recoil pad 10 exhibits surprisingly superior characteristics in its shock absorption and memory in returning to its equilibrium position after absorbing a shock, among other desirable characteristics.

In embodiments, the outer shell 40 can be formed of any suitable rubber or rubber-like material. One such materials is Natural Rubber (55-60 Shore A Black) available from Advanced Antivibration Components) of New Hyde Park, N.Y. (www.vibrationmounts.com). Different densities or thicknesses may be used depending upon the desired properties and result.

The interior region in the embodiments described herein is filled with Sorbothane. The outer shell allows the material used in the interior region to provide cushioning without the necessity of withstanding the wear and tear associated with use on a rifle.

Recoil pads in accordance with the present invention can be fabricated in different manners using known techniques. In the present embodiment, the rubber outer shell 40 is first fabricated by injection molding using known techniques. The outer shell is then fitted within a mold (not shown) and the Sorbothane is heated to a liquid state and poured into the rubber cavity of the recoil pad, where it will cool and harden to a specified durometer. The backing plate is then secured by an adhesive. After the Sorbothane hardens, the recoil pad may be attached to a rifle or shotgun stock, such as shown in FIG. 1.

It is also believed that embodiments can be manufactured by first forming the Sorbothane inner region 50 in a mold, then spraying on rubber to form the outer shell 40.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A recoil pad comprising:
a backing plate configured to be affixed to a stock of a rifle or shotgun;
a shell coupled to the backing plate, the shell and backing plate defining an interior region; and
the interior region filled with Sorbothane®.

2. The recoil pad of claim 1 wherein the shell is formed of rubber.

3. A recoil pad for installation on the back of a gun stock, comprising:
an exterior shell formed of a durable material; and
an interior region formed of Sorbothane®, the recoil pad configured to absorb recoil shock from a gun.

4. The recoil pad of claim 3 wherein the exterior shell comprises rubber.

5. A method of manufacturing a recoil pad for use with a stock of a rifle or shotgun, the method comprising:
providing a backing plate configured to be attached to a rifle or shotgun stock;
attaching a rubber shell to the backing plate, wherein the rubber shell and backing plate define an interior region;
heating Sorbothane® until it becomes a liquid;
placing the liquid Sorbothane® into the interior region; and
cooling the Sorbothane® until it hardens.
